(19) United States
(12) Patent Application Publication
(10) Pub. No.: US 2025/0208010 A1
(43) Pub. Date: Jun. 26, 2025

(54) EMBEDDING SYSTEM AND EMBEDDING METHOD

(71) Applicant: Leica Biosystems Nussloch GmbH, Nussloch (DE)

(72) Inventors: Chun JIN, Shanghai (CN); Jay CHEN, Shanghai (CN); Jingjing CAO, Shanghai (CN); Hongjian TAO, Shanghai (CN)

(21) Appl. No.: 18/849,985

(22) PCT Filed: Mar. 24, 2022
(86) PCT No.: PCT/CN2022/082746

§ 371 Date: Sep. 23, 2024

(51) Int. Cl. G01N 1/36; G01N 1/42

(52) U.S. Cl. CPC G01N 1/36; G01N 1/42; G01N 2001/366

(57) ABSTRACT

An embedding system and an embedding method are provided. The embedding system includes: a cooling container defining a cavity having an opening; a cooling liquid contained in the cavity of the cooling container; a mold arranged in the cavity and at least partially immersed in the cooling liquid, when cooled by the cooling container; and an embedding medium arranged in the mold and a sample enclosed in the embedding medium, when the mold is cooled by the cooling container. The mold is configured to exchange heat with the cooling liquid in such a manner that the embedding medium is cooled and solidified by the cooling liquid to embed the sample in the embedding medium.

### CROSS-REFERENCE TO RELATED APPLICATION(S)

This application is the national phase of PCT Application No. PCT/CN2022/082746 filed on Mar. 24, 2022, the disclosure of which is incorporated herein by reference.

### FIELD

The present disclosure relates to a field of tissue processing and embedding, and more particularly to an embedding system and an embedding method.

### BACKGROUND

Currently, a mold is usually arranged on a heating plate to be pre-heated, the mold is used to accommodate a paraffin and a tissue, and the mold carried with the paraffin and the tissue is further arranged on a cooling plate to solidify the paraffin and embed the tissue in the paraffin.

However, the heat transfer between the mold and the cooling plate via a direct surface contact is not consistent and sufficient. Further, a surface of the cooling plate tends to have frost, thereby reducing the efficiency of cooling the paraffin. Moreover, the frost formed on the cooling plate will hinder the movement of the mold, and thus the mold has to be moved manually.

### SUMMARY

Embodiments of the present disclosure seek to solve at least one of the problems existing in the prior art to at least some extent, and thus provide an embedding system and an embedding method.

According to embodiments of a first aspect of the present disclosure, there is provided an embedding system. The embedding system includes: a cooling container defining a cavity having an opening; a cooling liquid contained in the cavity of the cooling container; a mold arranged in the cavity and at least partially immersed in the cooling liquid, when cooled by the cooling container; and an embedding medium accommodated in the mold and a sample enclosed in the embedding medium, when the mold is cooled by the cooling container. The mold is configured to exchange heat with the cooling liquid in such a manner that the embedding medium is cooled and solidified by the cooling liquid to embed the sample in the embedding medium.

In the embedding system according to embodiments of the present disclosure, since at least part of the mold is immersed in the cooling liquid, the mold can be cooled by the cooling liquid at a temperature lower than 0° C., without any frost being formed to hinder movements of the mold, for example from the cooling container to other components such as a heating device of the embedding system. Thus, it is convenient to achieve an automatic embedding cycle by regularly moving the mold between the cooling container and the heating device. Moreover, a friction between the cooling liquid in the cooling container and the mold is approximate to zero, which further facilitates the movement of the mold relative to the cooling container. In addition, compared with the heat transfer efficiency between the mold and a cooling plate in the related art, the thermal resistance between the mold 3 and the cooling liquid in the cooling container is relatively small, so that the heat transfer efficiency between the mold and the cooling container 1 in the present disclosure is improved greatly.

In some embodiments, the cooling container includes a cooling pipe for cooling the cooling liquid, and the cooling pipe is arranged in the cavity.

In some embodiments, the cooling container includes a cooling pipe for cooling the cooling liquid, and the cooling pipe is arranged outside the cavity and attached to an outer surface of the cooling container.

In some embodiments, the cooling liquid includes glycerin, ethylene glycol or ethanol.

In some embodiments, the cooling liquid is configured to be cooled to a temperature as low as −20° C.

In some embodiments, the embedding system further includes a heating device configured to heat the mold, the heating device is thermally insulated from the cooling container, and the mold is arranged on the heating device when heated by the heating device.

In some embodiments, the cooling container and the heating device are arranged side by side, and a surface of the heating device on which the mold is arranged when heated by the heating device is substantially flush with a liquid level of the cooling liquid in the cavity.

In some embodiments, the heating device includes a heat-conductive metal plate and a heating element, the mold is arranged on a first surface of the heat-conductive metal plate when heated by the heating device, the heating element is arranged on a second surface of the heat-conductive metal plate, and the first surface of the heat-conductive metal plate faces away from the second surface of the heat-conductive metal plate.

In some embodiments, the heating element is encapsulated on the second surface of the heat-conductive metal plate by an insulating material, and the heating element comprises a heating wire or an etched heating sheet.

In some embodiments, the embedding system further includes a cassette arranged in the mold and accommodating the embedding medium and the sample therein, when the mold is cooled by the cooling container.

Embodiments of a second aspect of the present disclosure further provide an embedding method. The embedding method includes: providing a cooling container defining a cavity having an opening, the cavity containing a cooling liquid in the cavity; placing a mold carried with an embedding medium and a sample into the cavity of the cooling container through the opening, and at least partially immersing the mold in the cooling liquid; and cooling and solidifying the embedding medium to embed the sample in the embedding medium by heat exchange between the mold and the cooling liquid in the cooling container.

In the embedding method according to the embodiments of the present disclosure, since at least part of the mold is immersed in the cooling liquid, the mold can be cooled by the cooling liquid at a temperature lower than 0° C., without any frost being formed to hinder movements of the mold, for example from the cooling container to other components such as a heating device. Thus, it is convenient to achieve an automatic embedding cycle by regularly moving the mold between the cooling container and the heating device. Moreover, a friction between the cooling liquid in the cooling container and the mold is approximate to zero, which further facilitates the movement of the mold relative to the cooling container. In addition, compared with the heat transfer efficiency between the mold and a cooling plate in the related art, the thermal resistance between the mold and the cooling liquid in the cooling container is relatively small, so that the heat transfer efficiency between the mold and the cooling container in the present disclosure is improved greatly.

In some embodiments, after the embedding medium is cooled and solidified, the embedding method further includes unloading a solidified block from the mold. The solidified block includes the solidified embedding medium and the sample embedded in the solidified embedding medium.

In some embodiments, before placing the mold into the cavity of the cooling container, the embedding method further includes: providing a heating device thermally insulated from the cooling container; placing the mold on the heating device and heating the mold by the heating device; and placing the sample in the mold and introducing the embedding medium into the mold.

In some embodiments, after unloading the solidified block, the embedding method further includes: moving the mold from the cooling container onto the heating device for receiving another sample.

In some embodiments, placing the sample in the mold includes: providing a cassette, placing the cassette in the mold and placing the sample in the cassette; or providing a cassette, placing the sample in the cassette and placing the cassette carried with the sample in the mold.

In some embodiments, the solidified block further includes the cassette, and the cassette, the embedding medium and the sample are integrated into one piece after the embedding medium is cooled and solidified.

In some embodiments, the embedding medium is introduced into the mold after or before the sample is placed in the mold.

In some embodiments, the cooling liquid includes glycerin, ethylene glycol or ethanol.

In some embodiments, the cooling liquid is configured to be cooled to a temperature as low as −20° C.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference the accompanying drawings.

FIG. 1 is a perspective sectional view of an embedding system according to an embodiment of the present disclosure.

FIG. 2 is another perspective sectional view of an embedding system according to an embodiment of the present disclosure.

FIG. 3 is a perspective sectional view of a cooling container of an embedding system according to an embodiment of the present disclosure.

FIG. 4 is another perspective sectional view of a cooling container of an embedding system according to an embodiment of the present disclosure.

FIG. 5 is a perspective sectional view of a heating device of an embedding system according to an embodiment of the present disclosure.

FIG. 6 is a block diagram of an embedding method according to an embodiment of the present disclosure.

FIG. 7 is another block diagram of an embedding method according to an embodiment of the present disclosure.

FIG. 8 is another block diagram of an embedding method according to an embodiment of the present disclosure.

FIG. 9 is another block diagram of an embedding method according to an embodiment of the present disclosure.

FIG. 10 is a block diagram of a step of an embedding method according to an embodiment of the present disclosure.

FIG. 11 is a block diagram of a step of an embedding method according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, Unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

Terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also, it is to be understood that phraseology and terminology used herein with reference to device or element orientation (such as, for example, terms like “central,” “upper,” “lower,” “front,” “rear,” and the like) are only used to simplify description of the present disclosure, and do not alone indicate or imply that the device or element referred to must have a particular orientation.

In addition, terms such as “first” and “second” are used herein for purposes of description and are not intended to indicate or imply relative importance or significance.

According to embodiments of the present disclosure, an embedding system includes a cooling container, a cooling liquid, a mold, an embedding medium and a sample. The cooling container defines a cavity, and the cavity has an opening. The cooling liquid is contained in the cavity of the cooling container. The mold is arranged in the cavity and at least partially immersed in the cooling liquid when cooled by the cooling container. The embedding medium is accommodated in the mold and the sample is enclosed in the embedding medium, when the mold is cooled by the cooling container. The mold is further configured to exchange heat with the cooling liquid so that the embedding medium is cooled and solidified by the cooling liquid to embed the sample in the embedding medium.

Specifically, as shown in FIG. 1, embodiments of the present disclosure provide an embedding system 100, and the embedding system 100 includes a cooling container 1, a cooling liquid 2, a mold 3, an embedding medium 5 and a sample 6. The cooling container 1 defines a cavity 11 and the cavity 11 has an opening 111. The cooling liquid 2 is contained in the cavity 11 of the cooling container 1. That is, the cooling liquid 2 may be poured into or out of the cavity 11 through the opening 111. The mold 3 is arranged in the cavity 11 and at least partially immersed in the cooling liquid 2 when cooled by the cooling container 1. For example, the mold 3 may be arranged in the cavity 11 of the cooling container 1, and at least part of the mold 3 may immersed in the cooling liquid 2 in the cavity 11, when the mold 3 needs to be cooled by the cooling container 1. That is, the mold 3 is movable, and can be placed in the cooling container 1 when it needs to be cooled, or can be removed from the cooling container 1 when it does not need to be cooled. Further, the embedding medium 5 is accommodated in the mold 3 and the sample 6 is enclosed in the embedding medium 5, when the mold 3 is cooled by the cooling container 1. The embedding medium 5 may be a paraffin or the like, and the sample 6 may be a tissue sample or the like. The mold 3 is configured to exchange heat with the cooling liquid 2 in such a manner that the embedding medium 5 is cooled and solidified by the cooling liquid 2 to embed the sample 6 in the embedding medium 5. In other words, the mold 3 can be cooled by the cooling liquid 2 in the cavity 11, so as to cool and solidify the embedding medium 5 in the mold 3, thus embedding the sample 6 in the solidified embedding medium 5. Specifically, the cooling liquid 2 in the cooling container 1 may be cooled to a temperature lower than 0° C., so that the mold 3 and the embedding medium 5 in the mold 3 can be cooled quickly and efficiently.

In the embedding system 100 according to the embodiments of the present disclosure, since the at least part of the mold 3 is immersed in the cooling liquid 2, the mold 3 can be cooled by the cooling liquid 2 at the temperature lower than 0° C., without any frost being formed to hinder movements of the mold 3, for example from the cooling container 1 to other components such as a heating device of the embedding system 100. Thus, it is convenient to achieve an automatic embedding cycle by regularly moving the mold 3 between the cooling container 1 and the heating device. Moreover, a friction between the cooling liquid 2 in the cooling container 1 and the mold 3 is approximate to zero, which further facilitates the movement of the mold 3 relative to the cooling container 1. In addition, compared with the heat transfer efficiency between the mold and a cooling plate in the related art, the thermal resistance between the mold 3 and the cooling liquid 2 in the cooling container 1 is relatively small, so that the heat transfer efficiency between the mold 3 and the cooling container 1 in the present disclosure is improved greatly.

In the embodiments of the present disclosure, after the embedding medium 5 is cooled and solidified, a solidified block is formed and may be unloaded from the mold 3, and the solidified block includes the solidified embedding medium 5 and the sample 6 embedded in the solidified embedding medium 5.

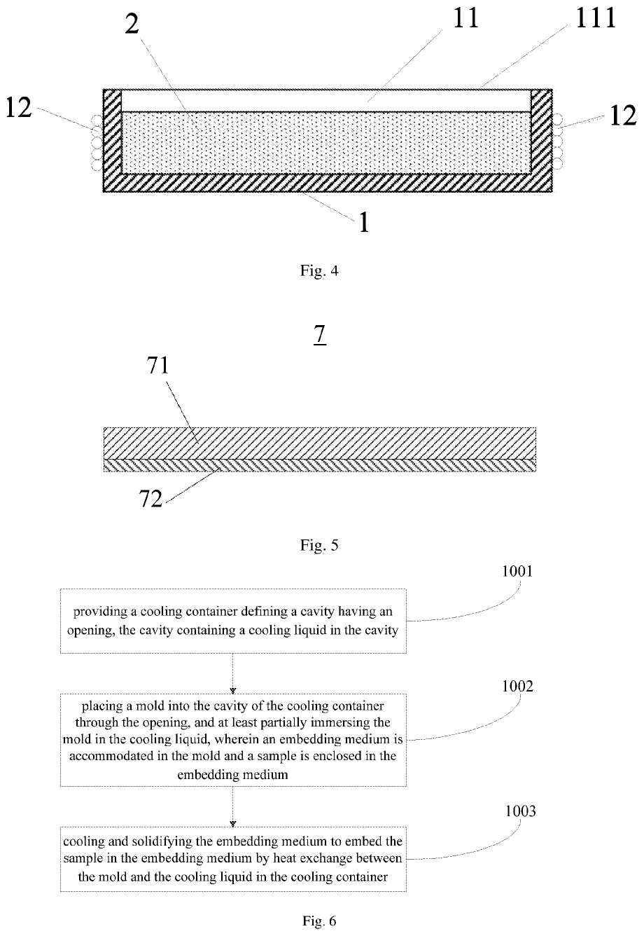

In some embodiments of the present disclosure, as shown in FIGS. 3 and 4, the cooling container 1 includes a cooling pipe 12 for cooling the cooling liquid 2, and a coolant may flow through the cooling pipe 12 to exchange heat with the cooling liquid 2 in the cavity 11 so as to cool the cooling liquid 2 to the temperate lower than 0° C., for example a temperature as low as −20° C., particularly a temperature in a range from −4° C. to −15° C. That is, the temperature of the cooling liquid 2 may range from an ambient temperature to −20° C., particularly from −4° C. to −15° C.

In some embodiments, the cooling liquid 2 may include glycerin, ethylene glycol or ethanol, which results in a large cooling efficiency. However, the cooling liquid 2 may also include other compounds, and this is not limited in the present disclosure.

As shown in FIG. 3, the cooling pipe 12 is arranged in the cavity 11 and adjacent to a bottom of the cavity 11, so as not to interfere with the mold 3 arranged in the cavity 11 when cooled by the cooling container 1. For example, a plurality of cooling pipes 12 may be arranged in layers from bottom to top, and each layer may include multiple cooling pipes 12 arranged side by side across the whole bottom of the cavity 11.

In some other embodiments, the cooling pipe 12 may be arranged in the cavity 11 and extend along a periphery of the cavity 11, so as not to interfere with the mold 3 arranged in the cavity 11 when cooled by the cooling container 1. That is, the cooling pipe 12 may be bent along the periphery of the cavity 11, or several pipe segments extending along the side walls of the cooling container 1 may be jointed into the cooling pipe 12.

For example, a plurality of cooling pipes 12 may be arranged in layers from bottom to top, while each layer may include one cooling pipe 12 extending along an inner peripheral surface of the cooling container 1, thus reserving a central portion of the cooling container 1 for receiving the mold 3. It may be understood that the number of the cooling pipes 12 in each layer is not limited in the present disclosure. For example, two or more cooling pipes 12 may be arranged side by side in each layer and extend along the periphery of the cavity 11, as long as a sufficient space can be remained in middle of the cooling container 1, so as not to affect the arrangement and movement of the mold 3.

As shown in FIG. 4, in some embodiments of the present disclosure, the cooling pipe 12 is arranged outside the cavity 11 and attached to an outer surface of the cooling container 1, so that the cooling pipe 12 will not interfere with the mold 3 arranged in the cooling container 1 when cooled by the cooling container 1, and also can cool the cooling liquid 2 in the cavity 11 effectively. Further, the cooling pipe 12 may also surround the cooling container 1, thus ensuring the cooling effect on the cooling liquid 2.

For example, a plurality of cooling pipes 12 may be arranged in layers from bottom to top, while each layer may include one cooling pipe 12 extending along an outer peripheral surface of the cooling container 1. In this case, the cooling pipes 12 even may be arranged in a height around a liquid level of the cooling liquid 2 in the cavity 11, thus further ensuring the cooling effect and the cooling efficiency on the cooling liquid 2. It also may be understood that the number of the cooling pipes 12 in each layer is not limited in the present disclosure. For example, two or more cooling pipes 12 may be arranged side by side in each layer and extend along the outer peripheral surface of the cooling container 1, according to actual cooling requirements.

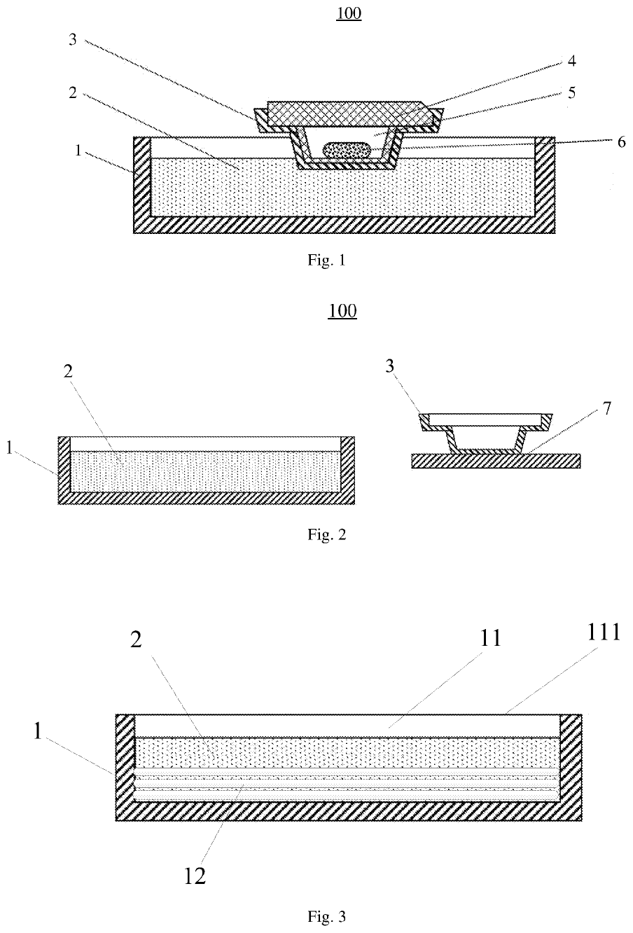

In some embodiments of the present disclosure, as shown in FIGS. 2 and 5, the embedding system 100 further includes a heating device 7 configured to heat the mold 3, the heating device 7 is thermally insulated from the cooling container 1, and the mold 3 is arranged on the heating device 7 when heated by the heating device 7, particularly before the embedding medium 5 is accommodated in the mold 3.

The embedding medium 5 usually is in a fluid state when introduced into the mold 3, and thus the mold 3 may be preheated by the heating device 7, so that the embedding medium 5 can flow into every corner of the mold 3 without being cooled and solidified during introduction into the mold 3, thereby ensuring the introduction rate and efficiency of the embedding medium 5 into the mold 3. Thus, the sample 6 can be fully enclosed in the embedding medium 5, and the solidified block finally formed can have flat surfaces so as to be complete and firm.

Moreover, after the mold 3 is cooled in the cooling container 1 to solidify the embedding medium 5, and the solidified embedding medium 5 together with the sample 6 embedded in the solidified embedding medium 5 is unloaded from the mold 3, the mold 3 may also be moved onto the heating device 7 to heat and melt the medium 5 remaining in the mold 3, so as to be ready for a subsequent embedding process of another sample 6.

As shown in FIG. 2, the cooling container 1 and the heating device 7 are arranged side by side, but should be thermally insulated as described above, and a surface of the heating device 7 on which the mold 3 is arranged when heated by the heating device 7 is substantially flush with the liquid level of the cooling liquid 2 in the cavity 11. Thus, when the mold 3 carried with the embedding medium 5 in the fluid state is moved from the heating device 7 to the cooling container 1, the embedding medium 5 in the fluid state will not overflow, so as not to affect the embedding of the sample 6 and the formation of the solidified block.

In some embodiments, as shown in FIG. 5, the heating device 7 includes a heat-conductive metal plate 71 and a heating element 72, the mold 3 is arranged on a first surface of the heat-conductive metal plate 71 when heated by the heating device 7, and the heating element 72 is arranged on a second surface of the heat-conductive metal plate 71. The first surface of the heat-conductive metal plate 71 faces away from the second surface of the heat-conductive metal plate 72.

Thus, the heating element 72 can heat the heat-conductive metal plate 71, and the heat-conductive metal plate 71 can transfer heat to the mold 3 arranged on the first surface of the heat-conductive metal plate 71, so as to heat (or pre-heat) the mold 3.

Further, the heating element 72 may be encapsulated on the second surface of the heat-conductive metal plate 71 by an insulating material, and the heating element 72 may include a heating wire or an etched heating sheet. Thus, the heat generated by the heating element 72 can be prevented from being dissipated outside, i.e. the heat from the heating element 72 can be fully used to heat the heat-conductive metal plate 71, thereby improving the heating efficiency of the heating element 72.

In some embodiments, the insulating material may include a silicone sheet or a polyimide film. However, the insulating material may also include any other suitable materials, which is not limited in the present disclosure.

As shown in FIGS. 1 and 2, the embedding system 100 further includes a cassette 4, and the cassette 4 is arranged in the mold 3 and accommodates the embedding medium 5 and the sample 6 therein, when the mold 3 is cooled by the cooling container 1. That is, when the mold 3 is cooled by the cooling container 1, the embedding medium 5 and the sample 6 are accommodated in the cassette 4, and the cassette 4 is arranged in the mold 3.

In this case, the solidified block finally formed further includes the cassette 4, and the cassette 4, the embedding medium 5 and the sample 6 are integrated into one piece after the embedding medium 5 is cooled and solidified. That is, the cassette 4, the embedding medium 5 and the sample 6 are processed into the solidified block after the embedding medium 5 is cooled and solidified.

Embodiments of the present disclosure further provide an embedding method, which may use the embedding system 100 according to any one of the above embodiments of the present disclosure. The embedding method includes following steps 1001-1003, as shown in FIG. 6.

At the step 1001, a cooling container 1 is provided, the cooling container 1 defines a cavity 11, the cavity 11 has an opening 111, and the cavity 11 contains a cooling liquid 2 in the cavity 11.

Further, the cooling liquid 2 can be poured into or out of the cavity 11 through the opening 111.

At the step 1002, a mold 3 is placed into the cavity 11 of the cooling container 1 through the opening 111, and the mold 3 is at least partially immersed in the cooling liquid 2. An embedding medium 5 is accommodated in the mold 3 and a sample 6 is enclosed in the embedding medium 5.

For example, the mold 3 may be arranged in the cavity 11 of the cooling container 1, and at least part of the mold 3 may immersed in the cooling liquid 2 in the cavity 11. Further, the embedding medium 5 may be a paraffin or the like, and the sample 6 may be a tissue sample or the like.

At the step 1003, the embedding medium 5 is cooled and solidified to embed the sample 6 in the embedding medium 5 by heat exchange between the mold 3 and the cooling liquid 2 in the cooling container 1.

In other words, the mold 3 can be cooled by the cooling liquid 2 in the cavity 11, so as to cool and solidify the embedding medium 5 in the mold 3, thus embedding the sample 6 in the solidified embedding medium 5. Specifically, the cooling liquid 2 in the cooling container 1 may be cooled to a temperature lower than 0° C., so that the mold 3 and the embedding medium 5 in the mold 3 can be cooled quickly and efficiently.

In the embedding method according to the embodiments of the present disclosure, since the at least part of the mold 3 is immersed in the cooling liquid 2, the mold 3 can be cooled by the cooling liquid 2 at the temperature lower than 0° C., without any frost being formed to hinder movements of the mold 3, for example from the cooling container 1 to other components such as the heating device. Thus, it is convenient to achieve an automatic embedding cycle by regularly moving the mold 3 between the cooling container 1 and the heating device. Moreover, a friction between the cooling liquid 2 in the cooling container 1 and the mold 3 is approximate to zero, which further facilitates the movement of the mold 3 relative to the cooling container 1. In addition, compared with the heat transfer efficiency between the mold and a cooling plate in the related art, the thermal resistance between the mold 3 and the cooling liquid 2 in the cooling container 1 is relatively small, so that the heat transfer efficiency between the mold 3 and the cooling container 1 in the present disclosure is improved greatly.

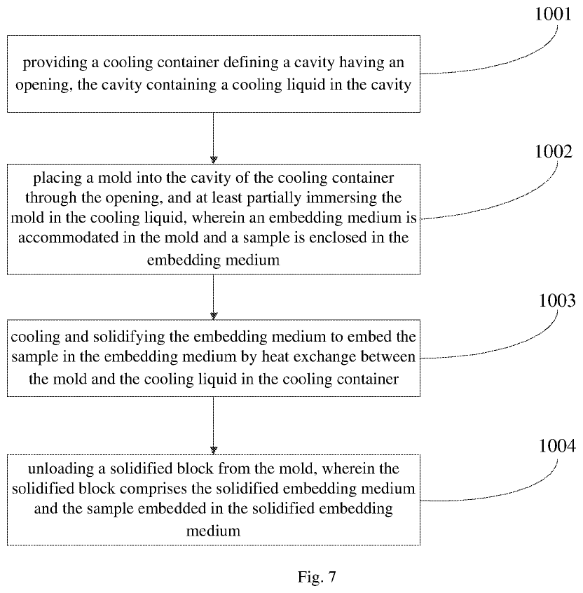

In some embodiments of the present disclosure, as shown in FIG. 7, after the embedding medium 5 is cooled and solidified, the embedding method further includes a step 1004.

At the step 1004, a solidified block is unloaded from the mold 3, and the solidified block includes the solidified embedding medium 5 and the sample 6 embedded in the solidified embedding medium 5.

For example, the solidified block may be unloaded from the mold 3 while the mold 3 remains in the cooling container 1, or after the mold 3 is removed out of the cooling container 1 to another place except a heating device, as long as the solidified block will not be heated and melt. Thus, it is convenient to unload the solidified block from the mold 3.

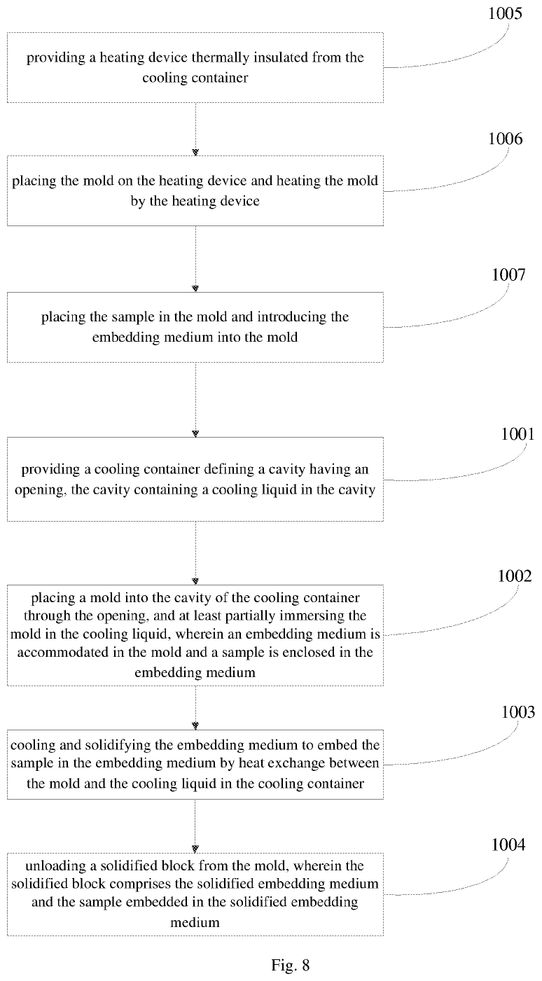

In some embodiments of the present disclosure, as shown in FIG. 8, before the mold 3 is placed into the cavity 11 of the cooling container 1, the embedding method further includes following steps 1005-1007.

At the step 1005, a heating device 7 thermally insulated from the cooling container 1 is provided.

For example, the cooling container 1 and the heating device 7 are arranged side by side, but should be thermally insulated, and a surface of the heating device 7 on which the mold 3 is arranged when heated by the heating device 7 is substantially flush with a liquid level of the cooling liquid 2 in the cavity 11.

At the step 1006, the mold 3 is placed on the heating device 7 and heated by the heating device 7.

At the step 1007, the sample 6 is placed in the mold 3 and the embedding medium 5 is introduced into the mold 3.

It may be understood that the sample 6 may be placed in the mold 3 after or before the mold 3 is preheated by the heating device 7, and the embedding medium 5 may introduced into the mold 3 after or before the sample 6 is placed in the mold 3. However, it is preferably ensured that the embedding medium 5 is introduced into the mold 3 after the mold 3 is heated by the heating device 7.

The embedding medium 5 usually is in a fluid state when introduced into the mold 3. Since the mold 3 is preheated by the heating device 7 before the embedding medium 5 is introduced into the mold 3, the embedding medium 5 can flow into every corner of the mold 3 without being cooled and solidified during introduction into the mold 3, thereby ensuring the introduction rate and efficiency of the embedding medium 5 into the mold 3. Thus, the sample 6 can be fully enclosed in the embedding medium 5, and the solidified block finally formed can have flat surfaces so as to be complete and firm.

Further, since the surface of the heating device 7 on which the mold 3 is arranged when heated by the heating device 7 is substantially flush with the liquid level of the cooling liquid 2 in the cavity 11, when the mold 3 carried with the embedding medium 5 in the fluid state is moved from the heating device 7 to the cooling container 1, the embedding medium 5 in the fluid state will not overflow, so as not to affect the embedding of the sample 6 and the formation of the solidified block.

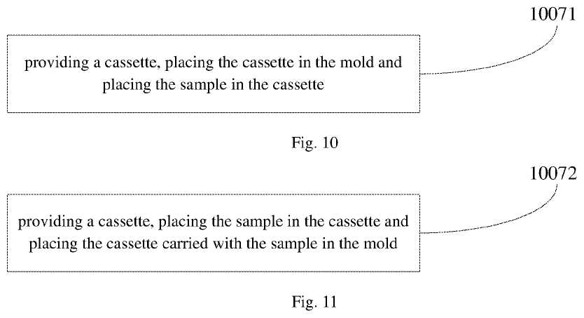

In some embodiments, the step 1007 may include sub-steps 10071 or 10072, as shown in FIGS. 10 and 11.

At the sub-step 10071, a cassette 4 is provided, the cassette 4 is placed in the mold 3 and the sample 6 is placed in the cassette 4.

At the sub-step 10072, a cassette 4 is provided, the sample 6 is placed in the cassette 4 and the cassette 4 carried with the sample 6 is placed in the mold 3.

In above either case, the solidified block finally formed further includes the cassette 4, and the cassette 4, the embedding medium 5 and the sample 6 are integrated into one piece after the embedding medium 5 is cooled and solidified. That is, the cassette 4, the embedding medium 5 and the sample 6 are processed into the solidified block after the embedding medium 5 is cooled and solidified.

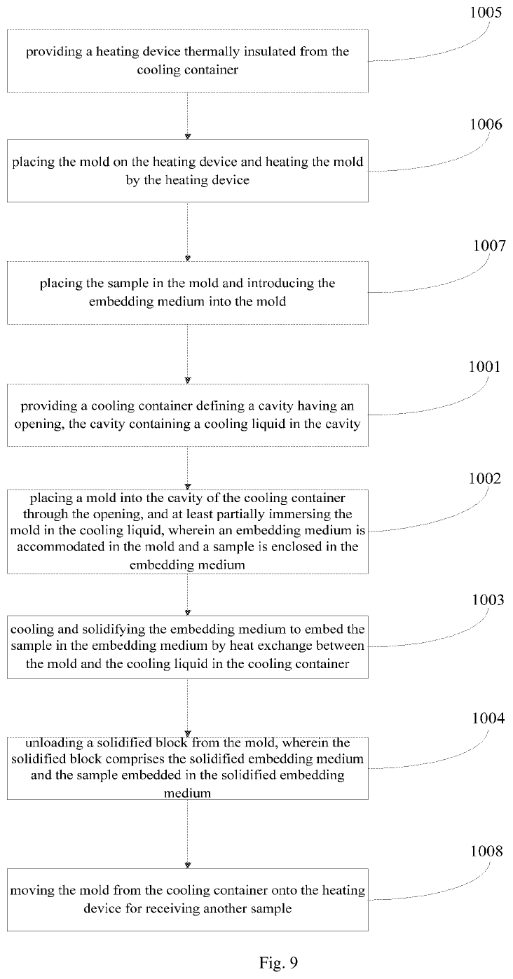

In some embodiments of the present disclosure, as shown in FIG. 9, after the solidified block is unloaded, the embedding method further includes a step 1008. At the step 1008, the mold 3 is moved from the cooling container 1 onto the heating device 7 for receiving another sample 6.

For example, after the mold 3 is cooled in the cooling container 1 to solidify the embedding medium 5, and the solidified embedding medium 5 together with the sample 6 embedded in the solidified embedding medium 5 (i.e. the solidified block) is unloaded from the mold 3, the mold 3 may also be moved onto the heating device 7 to heat and melt the medium 5 remaining in the mold 3, so as to be ready for a subsequent embedding process of another sample 6.

It may be understood that actions at the steps 1006-1007 may be repeated after the step 1008, and actions at the steps 1002-1004 and 1008 may also be repeated after the actions at the steps 1006-1007 are completed, thus resulting in an embedding cycle.

In the embedding method according to the embodiments of the present disclosure, since no frost is formed when the mold 3 is cooled by the cooling liquid 2 in the cooling container 1, and the friction between the mold 3 and the cooling liquid 2 in the cooling container 1 is approximate to zero, it is possible to automatically move the mold 3 between the cooling container 1 and the heating device 7 by an automatic apparatus, thus realizing the automatic embedding cycle.

For example, after the sample 6 is arranged in the mold 3 and the embedding medium 5 is introduced into the mold 3, the mold 3 can be automatically moved from the heating device 7 to the cooling container 1 so as to solidify the embedding medium 5 and embed the sample 6 in the embedding medium 5. Further, after the solidified block is unloaded from the mold 3, the mold 3 can also be automatically moved from the cooling container 1 to the heating device 7 so as to melt the embedding medium 5 remaining in the mold 3 for another embedding cycle.

Reference throughout this specification to “an embodiment,” “some embodiments,” “one embodiment”, “another example,” “an example,” “a specific examples,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example, “in an example,” “in a specific examples,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. An embedding system, comprising:
a cooling container defining a cavity having an opening;
a cooling liquid contained in the cavity of the cooling container;
a mold arranged in the cavity and at least partially immersed in the cooling in a cooling position for cooling by the cooling container (1); and
an embedding medium accommodated in the mold and a sample enclosed in the embedding medium, when the mold is in the cooling position,
wherein the mold is configured to exchange heat with the cooling liquid in such a manner that the embedding medium is cooled and solidified by the cooling liquid to embed the sample in the embedding medium.

2. The embedding system according to claim 1, wherein the cooling container comprises a cooling pipe for cooling the cooling liquid, and the cooling pipe is arranged in the cavity.

3. The embedding system according to claim 1, wherein the cooling container comprises a cooling pipe for cooling the cooling liquid, and the cooling pipe is arranged outside the cavity and attached to an outer surface of the cooling container.

4. The embedding system according to claim 1, wherein the cooling liquid comprises glycerin, ethylene glycol or ethanol.

5. The embedding system according to claim 1, wherein the cooling liquid (2) is configured to be cooled to a temperature as low as −20° C.

6. The embedding system according to claim 1, further comprising a heating device configured to heat the mold wherein the heating device is thermally insulated from the cooling container, and the mold is arranged on the heating device in a heating position.

7. The embedding system according to claim 6, wherein the cooling container and the heating device are arranged side by side, and a surface of the heating device on which the mold is arranged in the heating position is substantially flush with a liquid level of the cooling liquid in the cavity.

8. The embedding system according to claim 6, wherein the heating device comprises a heat-conductive metal plate and a heating element, the mold is arranged on a first surface of the heat-conductive metal plate in the heating position, the heating element is arranged on a second surface of the heat-conductive metal plate, and the first surface of the heat-conductive metal plate faces away from the second surface of the heat-conductive metal plate.

9. The embedding system according to claim 8, wherein the heating element is encapsulated on the second surface of the heat-conductive metal plate by an insulating material, and the heating element comprises a heating wire or an etched heating sheet.

10. The embedding system according to claim 1, further comprising a cassette arranged in the mold and accommodating the embedding medium and the sample therein, when the mold is in the cooling position.

11. An embedding method, comprising:
providing a cooling container defining a cavity having an opening, the cavity containing a cooling liquid in the cavity;
placing a mold into the cavity of the cooling container through the opening, and at least partially immersing the mold in the cooling liquid, wherein an embedding medium is accommodated in the mold and a sample is enclosed in the embedding medium; and
cooling and solidifying the embedding medium to embed the sample in the embedding medium by heat exchange between the mold and the cooling liquid in the cooling container.

12. The embedding method according to claim 11, further comprising, after the embedding medium is cooled and solidified, unloading a solidified block from the mold, wherein the solidified block comprises the solidified embedding medium and the sample embedded in the solidified embedding medium.

13. The embedding method according to claim 12, further comprising, before placing the mold into the cavity of the cooling container, further comprising:
providing a heating device thermally insulated from the cooling container;
placing the mold on the heating device and heating the mold by the heating device; and
placing the sample in the mold and introducing the embedding medium into the mold.

14. The embedding method according to claim 13, further comprising, after unloading the solidified block:
moving the mold from the cooling container onto the heating device for receiving another sample.

15. The embedding method according to claim 13, wherein placing the sample in the mold comprises:
providing a cassette, placing the cassette in the mold and placing the sample in the cassette; or
providing a cassette, placing the sample in the cassette and placing the cassette carried with the sample in the mold.

16. The embedding method according to claim 15, wherein the solidified block further comprises the cassette, and the cassette, the embedding medium and the sample are integrated into one piece after the embedding medium is cooled and solidified.

17. The embedding method according to claim 13, wherein the embedding medium is introduced into the mold after or before the sample is placed in the mold.

18. The embedding method according to claim 11, wherein the cooling liquid comprises glycerin, ethylene glycol or ethanol.

19. The embedding method according to claim 11, wherein the cooling liquid is configured to be cooled to a temperature as low as −20° C.

20. The embedding method according to claim 13, wherein the embedding medium is introduced into the mold before the sample is placed in the mold.
